(19) United States
(12) Patent Application Publication
(10) Pub. No.: US 2008/0135356 A1
(43) Pub. Date: Jun. 12, 2008

(54) Transmission motor structure

(76) Inventor: Yungh-Siang Lin, Shueishang Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/634,183

(22) Filed: Dec. 6, 2006

(51) Int. Cl. B60T 13/74

(52) U.S. Cl. 188/158

(57) ABSTRACT

A transmission motor structure includes a motor, an interruption device, and a transmission mechanism; the interruption device includes a bearing positioned around an output shaft of the motor, and a pressing plate secured to the output shaft; the transmission mechanism includes a main drive wheel connected to the output shaft, and a driven wheel connected to a moving element of a moving apparatus; the pressing plate of the interruption device is tightly pressed against the main drive wheel; when the motor is running, the pressing plate will make the main drive wheel rotate together with it owing to frictional force between them, thus causing displacement of the moving element of the moving apparatus; the pressing plate will begin to rub on the main drive wheel, producing warning sound with the motor running idly, when the moving element is moved to one of its extreme positions, and the driven wheel stopped.

### BACKGROUND OF THE INVENTION

1. Field of the invention

The present invention relates to an improvement on a transmission motor, more particularly one, which has a relatively uncomplicated mechanical structure, and allows the operators to easily notice when they should turn off the motor, thus preventing waste of electrical energy.

2. Brief Description of the Prior Art

Conventionally, a motor is usually used with electronic devices such as micro-switches, and control boxes if the motor is used to cause displacement of an apparatus, which should stop moving after having moved to a predetermined position.

For example, a motor-driven elevator is equipped with a control box with control programs, and micro-switches at upper and lower ends thereof; thus, as soon as a car of the elevator is moved either one of the highest position and the lowermost one, the corresponding micro-switch will be automatically pressed so as to turn off the power to the motor, thus preventing unnecessary operation of the motor, which would cause damage to the various parts of the elevator and waste of electrical energy.

However, the above structure has the following disadvantages:

1. The manufacturing cost of the elevator, which mainly comprises mechanical components, will increase significantly owing to use of electronic devices such as the micro-switches and the control box.

2. The elevator will be more prone to malfunction because the micro-switches and the control box are electronic devices, which have a relatively high chance of fault as compared with common mechanical components.

3. The elevator will be more expensive to maintain because the micro-switches and the control box are electronic devices, which have a relatively high chance of fault, and need frequent maintenance.

### SUMMARY OF THE INVENTION

It is a main object of the present invention to provide an improvement on a transmission motor to overcome the above problems. The transmission motor includes a motor, an interruption device, and a transmission mechanism; the interruption device includes a first pad positioned around an output shaft of the motor, a bearing positioned on the first pad, and a pressing plate secured to the output shaft. The transmission mechanism includes a main drive wheel connected to the output shaft, and a driven wheel connected to an up and down moving element of a moving apparatus. The pressing plate is tightly pressed against the main drive wheel. When the motor is running, the pressing plate will make the main drive wheel rotate together with it owing to frictional force between them, thus causing displacement of the up and down moving element. And, the pressing plate will begin to continue rubbing on the main drive wheel, producing warning noise with the motor running idly, when the up and down moving element is moved to one of its extreme positions, and the driven wheel stopped.

### BRIEF DESCRIPTION OF THE DRAWINGS

The present invention will be better understood by referring to the accompanying drawings, wherein:

FIG. 1 is an exploded perspective view of the present invention,

FIG. 2 is a front sectional view of the present invention,

FIG. 3 is a top view of the present invention, and

FIG. 4 is a front sectional view, taken when the present invention is being used.

### DETAILED DESCRIPTION OF THE PREFERRED EMBODIMENTS

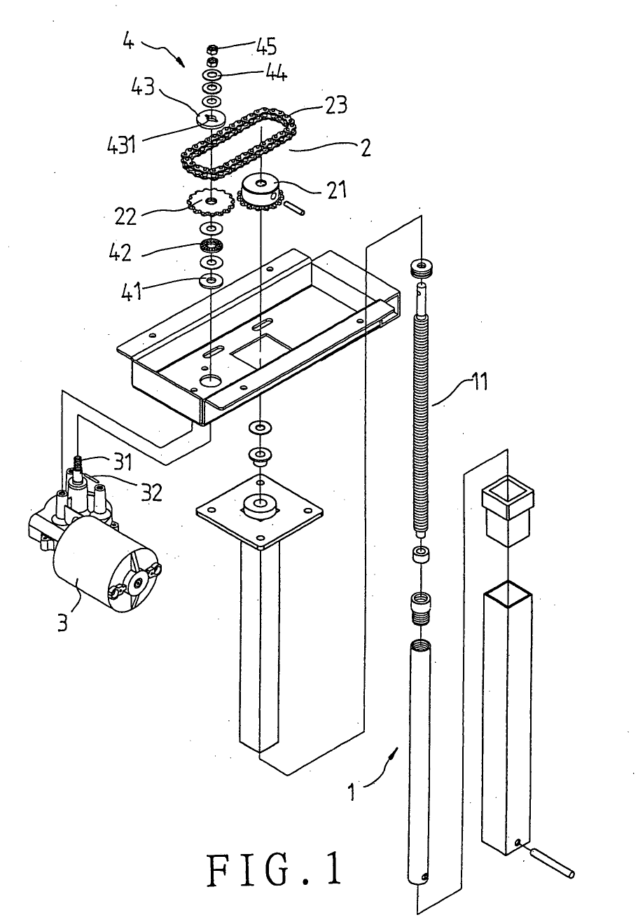

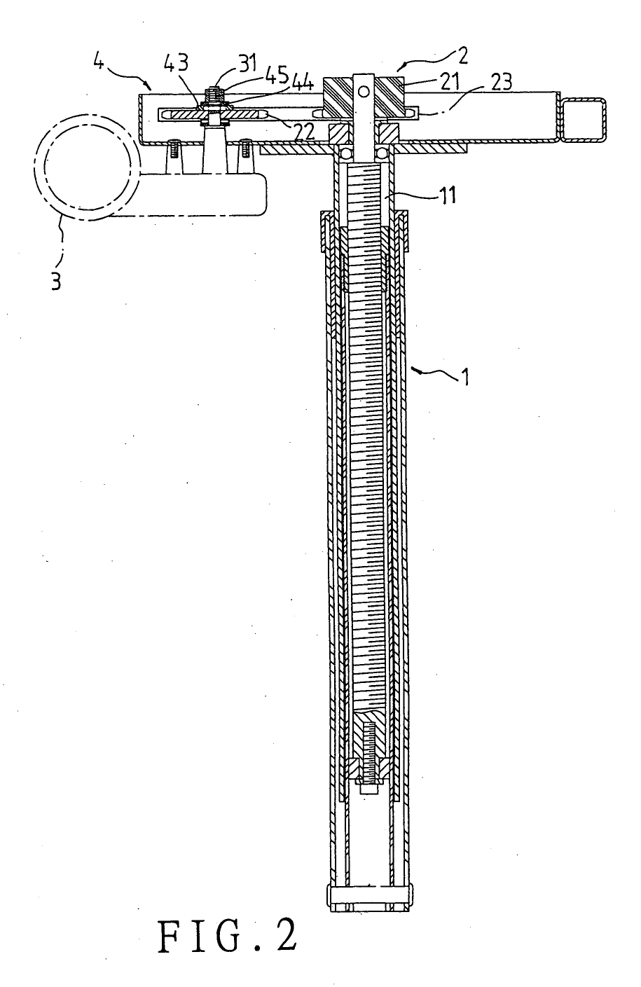

Referring to FIGS. 1 and 2, a preferred embodiment of a transmission motor of the present invention includes a transmission mechanism 2, a motor 3, and an interruption device 4. The transmission motor is connected to a moving apparatus 1. The actuating apparatus 1 can be a lifting and lowering one, and includes an up and down moving element 11.

The transmission mechanism 2 includes a driven wheel 21, a main drive wheel 22. The driven wheel 21 is connected to the up and down moving element 11 of the moving apparatus 1. The driven wheel 21 and the main drive wheel 22 can be a chain wheel. The transmission mechanism 2 further includes a co-moving element 23, which is passed over both the driven wheel 21 and the main drive wheel 22, and which can be a chain.

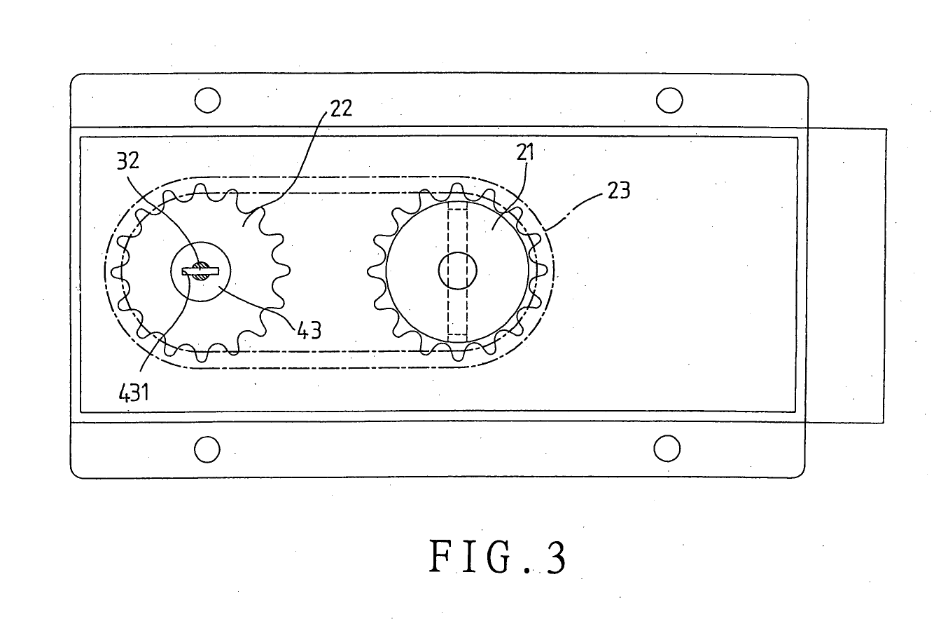

The interruption device 4 is interposed between and connected to an output shaft 31 of the motor 3 and the main drive wheel 22 of the transmission mechanism 2. The interruption device 4 includes a first pad 41, a bearing 42, a pressing plate 43, a second pad 44, and a fixing element 45. The first pad 41 is positioned around the output shaft 31 of the motor 3 while the bearing 42 is positioned on the first pad 41. The main drive wheel 22 is positioned on the bearing 42. The pressing plate 43 is positioned on the main drive wheel 22 and around the output shaft 31. The pressing plate 43 has holes 431 thereon, and an insertion pin 32 is inserted in the output shaft 31 of the motor 3 as well as being fitted in the holes 431 of the pressing plate 43; referring to FIG. 3 as well, owing to the insertion pin 32 inserted in the output shaft 31 and fitted in the holes 431 of the pressing plate 43, the pressing plate 43 is fixed to the output shaft 31 and tightly pressed against the main drive wheel 22. The pressing plate 43 is made of materials with a high coefficient of friction, e.g. plastics. The second pad 44 is positioned on the pressing plate 43 and around the output shaft 31 of the motor 3. And, a fixing element 45 such as a nut is secured around the output shaft 31 and tightly pressed against the second pad 44 so as to make the interruption device 4 firm on the output shaft 31.

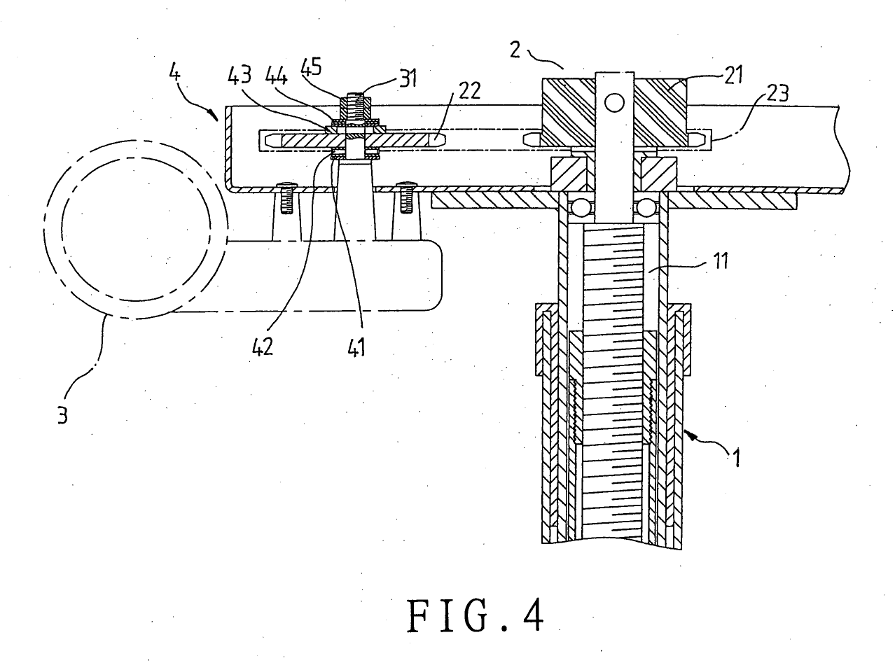

Referring to FIGS. 2 and 4, when the output shaft 31 of the motor 3 is rotating, the pressing plate 43 of the interruption device 4 will rotate with the output shaft 31, and make the main drive wheel 22 rotate owing to frictional force between the pressing plate 43 and the main drive wheel 22. At the same time, the main drive wheel 22 will make the driven wheel 21 rotate through the co-moving element 23; thus, the up and down moving element 11 connected to the driven wheel 21 will move up/down owing to rotation of the driven wheel 21.

The up and down moving element 11 can no longer move after it has been moved to either one of the highest position and the lowermost position. Consequently, the driven wheel 21 is stopped, and in turn the main drive wheel 22 becomes incapable of rotating; the pressing plate 43 is still rotating together with the output shaft 31 of the motor. 3, but it can't make the main drive wheel 22 rotate together with it because the frictional force between the pressing plate 43 and the main drive wheel 22 is smaller than a stopping force applied on the main drive wheel 22. Under such condition, the pressing plate 43 will start to continue rubbing on the main drive wheel 22 at a high speed, and produce noise, allowing the operators to notice that the motor 3 is running idly, and turn off power to the motor 3 without delay to prevent possible undesirable results.

From the above description, it can be seen that the present invention has the following advantages:

1. The main drive wheel of the transmission mechanism is made to rotate by frictional force between the main drive wheel and the pressing plate of the interruption device, and the frictional force will be smaller than a stopping force applied on the main drive wheel after the up and down moving element of the moving apparatus moves to the highest/lowermost position, and the driven wheel stopped. Therefore, the main drive wheel can no longer be rotated, and the motor can be prevented from continuing to run to cause damage to the transmission mechanism after the driven wheel is stopped.

2. The main drive wheel of the transmission mechanism is made to rotate by frictional force between the main drive wheel and the pressing plate of the interruption device. And, the main drive wheel can no longer be rotated by such frictional force after the up and down moving element of the moving apparatus moves to the highest/lowermost position, and the driven wheel stopped. Therefore, the pressing plate will start to continue rubbing on the main drive wheel, and produce noise, thus allowing the operators to notice that the motor is running idly, and turn off the motor without delay to prevent waste of electrical energy.

3. The interruption device of the present invention mainly comprises simple mechanical components such as pads, bearings, and pressing plates therefore it is relatively inexpensive to manufacture as compared with the above-mentioned equivalents equipped with electronic devices such as micro-switches and control boxes.

4. The interruption device of the present invention mainly comprises simple mechanical components such as pads, bearings, and pressing plates therefore it has relatively low chance of fault, and is relatively easy and inexpensive to maintain as compared with the above-mentioned equivalents comprising complicated electronic devices such as micro-switches and control boxes.

What is claimed is:

1. An improvement on a transmission motor structure, comprising
(a) a motor,
(b) an interruption device, including
a first pad positioned around an output shaft of the motor;
a bearing positioned on the first pad;
a pressing plate secured to the output shaft of the motor;
a second pad positioned on the pressing plate and around the output shaft of the motor; and
a fixing element securely joined to the output shaft of the motor and tightly pressed against the second pad; and
(c) a transmission mechanism including a main drive wheel, the transmission mechanism being connected to the output shaft of the motor as well as a moving apparatus; the pressing plate of the interruption device being tightly pressed against the main drive wheel.

2. The improvement on a transmission motor structure as recited in claim 1, wherein the pressing plate has holes thereon, and an insertion pin is inserted in the output shaft of the motor and fitted in the holes of the pressing plate so as to hold the pressing plate in position.

3. The improvement on a transmission motor structure as recited in claim 1, wherein the pressing plate is made of materials with a high coefficient of friction.

4. The improvement on a transmission motor structure as recited in claim 1, wherein the pressing plate is made of plastic materials.

5. The improvement on a transmission motor structure as recited in claim 1, wherein the fixing element is a nut.

6. The improvement on a transmission motor structure as recited in claim 1, wherein the transmission mechanism further includes a driven wheel, and a co-moving element passed over both the main drive wheel and the driven wheel; the main drive wheel being sandwiched between the bearing and the pressing plate of the interruption device; the driven wheel being connected to said moving apparatus.

7. The improvement on a transmission motor structure as recited in claim 6, wherein the main drive wheel is a chain wheel.

8. The improvement on a transmission motor structure as recited in claim 6, wherein the driven wheel is a chain wheel.

9. The improvement on a transmission motor structure as recited in claim 6, wherein the co-moving element is a chain.
